(19) United States
(12) Patent Application Publication
(10) Pub. No.: US 2005/0021409 A1
(43) Pub. Date: Jan. 27, 2005

(54) Application service provider point of sale system and method

(76) Inventors: Gene R. Michaud JR., Jacksonville, FL (US); John R. Huffman JR., Jacksonville, FL (US)

Correspondence Address: Mark J. Young;Suite 227, 9951 Atlantic Blvd., Jacksonville, FL, 32225, US

(21) Appl. No.: 10/892,844

(22) Filed: Jul. 16, 2004

Related U.S. Application Data
(60) Provisional application No. 60/487,816, filed on Jul. 16, 2003.

(51) Int. Cl. G06F 17/60

(52) U.S. Cl. 705/16

(57) ABSTRACT

An application service provider point of sale system and method provide point of sale transaction processing and management for subscribers through remote access and use of a point of sale system hosted on ASP server. A thin client device known as a lane commander provides input and output for point of sale transaction processing. The lane commander also provides an off-line mode that enables transaction processing in the event on-line access to the ASP server becomes disabled. Subscriber demand for third party products and services is aggregated to secure volume discounts for the subscribers.

### RELATED APPLICATIONS

This application claims priority to U.S. Provisional Application Ser. No. 60/487,816, filed Jul. 16, 2003, the entire contents of which are incorporated by reference herein.

### FIELD OF THE INVENTION

This invention generally relates to point of sale systems, and more particularly, to an application service provider (ASP) point of sale system and method for efficiently providing point of sale services, as well as value added services and volume discounts to users.

### BACKGROUND

For many retailers, Point of Sale (POS) systems are critical to efficiently processing transactions and managing their businesses. Running a successful retail business means much more than offering good products and swift service. A critical competitive advantage comes from having intimate knowledge of such basic information as which products sell best and when, and how many are needed in stock at any given time. This is where POS systems come in. Unlike traditional cash registers, POS systems allow retailers to efficiently process electronic (e.g., credit card and debit card) transactions, manage and optimize inventory, and streamline accounting.

Unfortunately, conventional POS systems have become rather complex and expensive. They typically have front-end lane devices which are, essentially, specially equipped computers that run POS software and communicate sales data with a back office server. In addition to requiring computers, hardware and network communications equipment, such systems have operating systems and POS software for each lane device, a network operating system and POS software for the back office, and countless complications that go along with a complicated distributed system.

Large and medium size retailers have long invested in POS systems to reduce cost, increase their efficiency and obtain a competitive edge, but adoption by small businesses has been (at best) limited. This lack of adoption is due to several factors: high cost, installation complexity, and the need to continuously provide skilled staff for operation and maintenance of in-house networked computers and POS systems.

While large and medium size retailers have grown accustomed to spending a substantial portion of their information technology budgets on point-of-sale technology, many small retailers who can benefit tremendously from POS systems simply cannot afford to acquire and maintain the complex and expensive hardware and software. Instead, they rely on inferior cash register-type systems and manual processing of sales and inventory data. This technological gap and the competitive disadvantage increase as large and medium size retailers implement more sophisticated POS systems.

Economies of scale also provide competitive advantages to large retailers. Volume discounts provide large retailers significant savings in costs of goods, credit/debit card transactions and more. Large retailers are, therefore, frequently able to offer the same goods at a lower price than small retailers and, at the same time, reap greater profits. As a result, many small retailers must struggle to survive.

The invention is directed to overcoming one or more of the problems as set forth above.

### SUMMARY OF THE INVENTION

To solve one or more of the problems set forth above, in a first aspect of an exemplary implementation of the invention, an application service provider point of sale system is provided. The system includes an ASP server having point of sale software, at least one remote lane commander for at least one subscriber, and communications connectivity between said at least one lane commander and said ASP server.

In a second aspect of an exemplary implementation of the invention, the ASP server further includes demand aggregation software.

In a third aspect of an exemplary implementation of the invention, the lane commander further includes pricing data for offline transaction processing.

In a fourth aspect of an exemplary implementation of the invention, an application service provider point of sale business method is provided. The method includes a step of providing an ASP server having point of sale software for access and use by the subscriber. An account is established for the subscriber on said point of sale software, thereby allowing subscriber access and use. A fee is charged to the subscriber for use of the point of sale software, said fee being based on point of sale transactions processed using the ASP server having point of sale software.

In a fifth aspect of an exemplary implementation of the invention, the application service provider point of sale business method includes a step of securing discounts for third party products or services purchased by subscribers.

In a sixth aspect of an exemplary implementation of the invention, an application service provider point of sale method is provided. The method entails receiving point of sale transaction requests from remote lane commanders, processing the point of sale transaction requests to produce transaction output, and transmitting said transaction output to said lane commanders.

### BRIEF DESCRIPTION OF THE DRAWINGS

The foregoing and other objects, aspects and advantages will be better understood from the following detailed description of an embodiment of the invention with reference to the drawings, in which:

FIG. 1 shows a high-level block diagram of a system upon which an exemplary implementation of the invention may be implemented;

FIG. 2 shows a high level diagram of a point of sale device for use in connection with an application service provider point of sale system in accordance with an exemplary implementation of the invention;

FIG. 3 is a flow diagram illustrating steps of an application service provider point of sale business methodology in accordance with an exemplary implementation of the invention; and

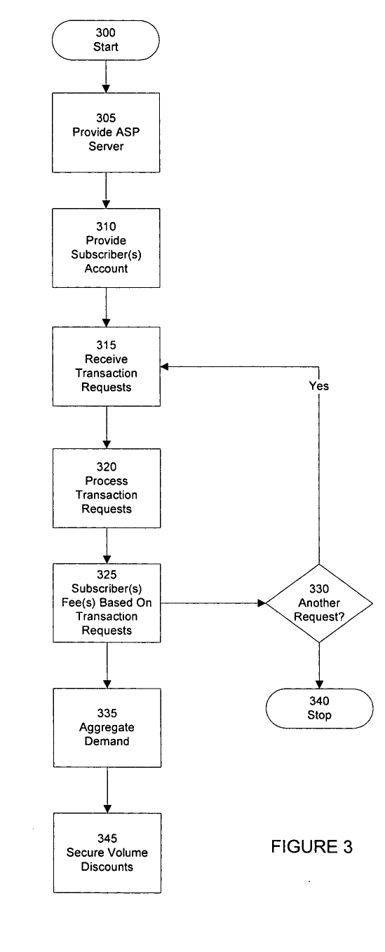

FIG. 4 is a flow diagram illustrating steps of an application service provider—point of sale methodology in accordance with an exemplary implementation of the invention.

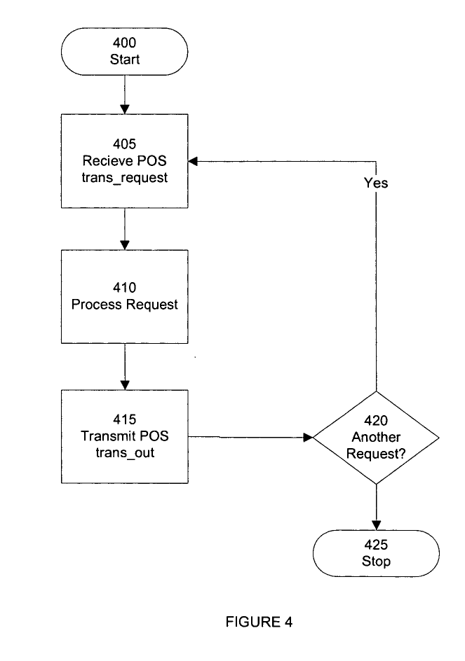

### DETAILED DESCRIPTION

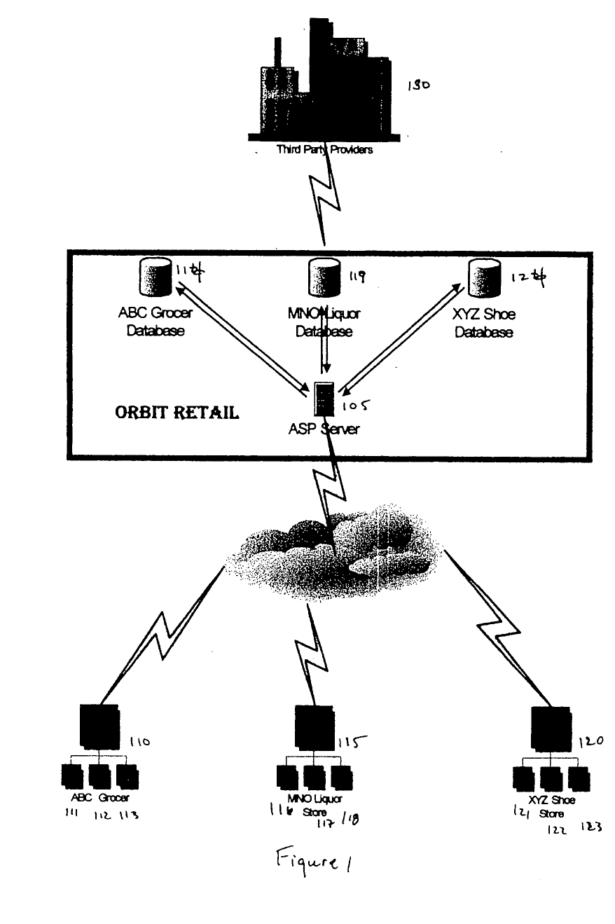

Referring to FIG. 1, a high-level schematic diagram of an application service provider (ASP) point of sale system in accordance with an exemplary implementation of the invention is shown. ASP server 105 hosts software for managing point of sale transactions and providing services. A plurality of subscribers 110, 115 and 120 access the ASP server 105 to perform point of sale transactions and obtain services. By way of example and not limitation, the services may include access to third party service providers 130. Access between the plurality of subscribers 110, 115 and 120 and the ASP server 105 is preferably via data communications networks, which may include the Internet. The ASP server 105 preferably maintains compilations of data (e.g., databases) 114, 119 and 123 for each of the plurality of subscribers 110, 115 and 120.

An exemplary ASP server 105 is comprised of a computer system, having a bus for communicating information, a central processing unit (CPU), a read only memory (ROM), a random access memory (RAM), a mass storage device and communications equipment. The storage device may include a hard disk, CD-ROM drive, DVD drive, tape drive, memory (e.g., EPROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software and point of sale application software are stored on and executable on the ASP server 105. The ASP server 105 runs the point of sale application software, which processes transactions, manages databases for subscribers' data and provides reports. Except for the point of sale application software, these elements are typically included in many computer servers. Indeed, the aforementioned ASP server 105 is intended to represent a broad category of computer systems capable of functioning as a computer server and hosting point of sale application software for network access and use by subscribers in accordance with the present invention. Of course, the ASP server 105 may include fewer, different and/or additional elements, functioning as a single server or as a distributed system, provided it is capable of performing the aforementioned functions in accordance with the present invention.

The ASP POS system provides many benefits. Advantageously, the ASP model provides a low cost of entry and short setup time for subscribers. In an exemplary implementation, subscribers pay a transaction fee for using the point of sale system, thus tying payment for use to a subscriber's sales.

The ASP model also eliminates the need for a specialized information technology infrastructure with costly and complex point of sale, network operating system and database management software. Furthermore, it reduces or eliminates the need for costly information technology staff.

Other advantages of the ASP model include access to a feature-rich preconfigured system and continued software and hardware updates at the ASP server.

In another aspect of the invention subscribers will have their own individual website hosted around a standard group-marketing program made possible because of the ASP format. Sites will be maintained for subscribers as part of the transaction fee. Subscribers will be able to use web sites for individual store promotions, coupons, general store information and community information as desired. Subscribers will also be able to participate in national and regional promotional programs from selected vendors. Additionally, subscribers will be able to participate in national and regional co-op advertising and have the funds credited back against their transaction fees.

In yet another aspect of the invention, an opt-in e-mail program, subscribers will be able to solicit their current customers for their e-mail address so that they can receive information on specials and events. Subscribers may maintain the program on a local basis and/or participate in a regional program and have the ASP host assist in producing and sending out periodic mails.

Each subscriber has at least one point of sale input/output device (referred to herein as a “lane commander”). The lane commander is preferably a thin client device that is a much simpler, less costly device than a conventional PC. Each lane commander has components needed for point of sale input and output and for communicating with the ASP server 105. By way of example and not limitation, three lane commanders 111-113, 116-118, 121-123 are conceptually shown for each subscriber in FIG. 1. Although three lane commanders are shown per subscriber, it will be appreciated that any number of these devices can be included and that subscribers may have different numbers of these devices.

Each lane commander is preferably communicatively coupled to a communications device to facilitate communication with the ASP server 105. In an exemplary implementation, all lane commanders in a subscriber's store share a single broadband connection, though other connections such as dedicated lines (e.g., TI), leased lines, ISDN and dial-up connections also come within the scope of the present invention. For example, a hardware device that combines a router, firewall and Ethernet hub (referred to herein as a “broadband router”) may be used to share a broadband connection among a plurality of lane commanders located in the same facility. Examples of such devices include Nexland Technology's ISB SOHO™, the Linksys (a division of Cisco Systems, Inc.) EtherFast Cable/DSL™, and the D-Link Systems, Inc. DI-704 Cable/DSL Internet Gateway™ Ethernet Router. Each is a cable/DSL router with a built-in, multi-port, 10/100-megabits per second (Mbps) Ethernet hub and support for bi-directional throughput. Of course, wireless access points and communications peripherals may also be used. Lane commanders in a subscriber's store connect to the broadband router, which in turn is connected to either a broadband cable or DSL modem. Subscribers may use the same or different broadband routers. Additionally, a subscriber may have more than one broadband connection, and more than one broadband router at a location without departing from the scope of the invention. Furthermore, subscribers may have a dial-up modem backup.

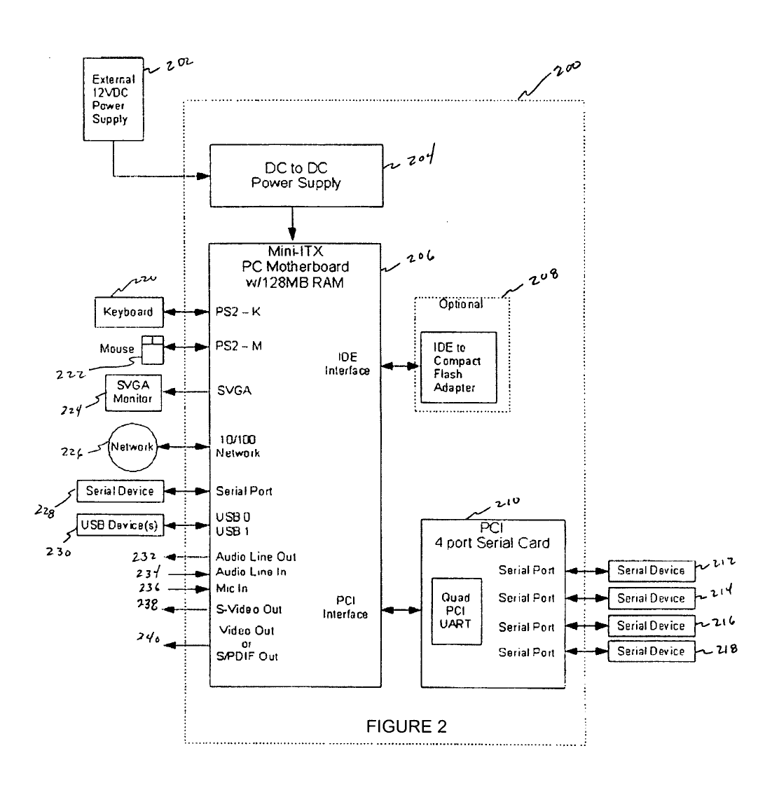

The lane commanders enable a wide variety of point of sale functions. Referring now to FIG. 2, each lane commander is preferably comprised of a motherboard 206 having a microprocessor (not shown), memory (not shown) and several interfaces and corresponding ports, including a plurality of PS-2 ports, a serial port 228, an integrated video port 224, audio 232-236, a plurality of Universal Serial Bus (USB) ports 230, an RJ-45 10/100 network interface port 226, and S-Video/composite Video-Out ports 238-240. The lane commander also preferably includes Integrated Drive Electronics (IDE) and Peripheral Component Interconnect (PCI) interfaces, 242 and 244 respectively, with a compact flash adapter 208 connected to the IDE interface 242 and a PCI multi-port (212-218) serial card 210 connected to the PCI interface 244.

The aforementioned lane commander components are not typically included in most standard configuration computer systems. Thus, typically only non-standard customized configurations, which substantially increase cost, would have these features. It is understood by those of skill in the art that lane commanders may be implemented using terminals comprised of digital signal processors (DSP), application-specific integrated circuits (ASIC), field programmable gate arrays (FPGA), discrete gate logic, or other hardware, firmware, or any Software modules and data could reside in ROM, RAM, flash memory, registers, or any other form of readable and writable storage medium known in the art.

Each lane commander preferably accommodates input/output devices necessary to perform a variety of checkout lane point of sale functions. A key attribute of the lane commander is that it combines into a single, compact, relatively inexpensive device, a plurality of components for performing checkout lane point of sale functions, including (by way of example) displaying prompts and accepting inputs (e.g., keyboard. barcode scanner, magnetic card, and smart card inputs) from a cashier and/or consumer. It does not require a conventional PC operating system and does not have extraneous components of conventional PCs.

More particularly, each lane commander may accommodate two keypads—one keypad facing the cashier and one facing the customer. The customer keypad may be used for privately entering personal identification numbers (PIN) for electronic debit as well as requests for cash back, debit or check tender. The cashier keypad may be used for entering purchase data, override information and any additional data that might be needed by the system.

Two displays may also be accommodated—one display facing the cashier and one facing the customer. Each display may be separately addressable by the lane commander to display different messages depending on the transaction type. For example, the customer display may display messages such as “Enter PIN Number”, “Do You Want Cash Back?” and “Thank You”. The cashier display may display messages such as product and purchase information, status information and the like. 10

A bar code scanning device is preferably accommodated for scanning barcoded media (e.g., goods and coupons). The bar code scanning device may be fixed mounted and/or a handheld scanner.

The lane commander also preferably accommodates one (and possibly two) magnetic stripe readers for manual swipe of credit/debit 3 cards, ATM cards used in EFT approval applications and electronic funds benefit cards issued to authorized recipients of food stamps. A magnetic stripe reader capable of reading and decoding tracks 1 and 2 from financial transaction cards may be included with PIN encryption. If two magnetic stripe readers are provided, then cards can be swiped by either the customer or the cashier. Because the lane commander includes an ability to read credit/debit cards and ATM cards, it preferably has an encryption device and/or software as is well known in the electronic transfer of financial information, for example, a DES encryption.

The lane commander may also accommodate a unit for reading coded bank and account information from customer checks during check approval, e.g., a check reader capable of reading and decoding an entire MICR line. Such a unit is able to read and decode common personal and business checks. The check reader is preferably connected to the lane commander on the cashier side of the checkout lane.

The lane commander also preferably accommodates a printer. The printer is used to print receipts for purchases and financial (e.g., debit) transactions. The printer is connected to the lane commander and may be located at any convenient area in the checkout lane, typically on the cashier side.

A beeper or speaker may be accommodated by the lane commander to signal good reads for barcodes, checks, magnetic cards and the like.

In a preferred implementation, lane commanders are configured to temporarily operate off-line in the event the ASP server becomes inaccessible or the communications connection fails. Pricing data (e.g., Universal Product Codes for products and corresponding prices for products) may be stored locally on the lane commander in memory (e.g., non-volatile memory) to enable an offline price determination. Upon detecting a failure to communicate with the ASP server, the lane commander may initiate fall-back mode operation, either manually by user selection or automatically upon determination of communication failure. While in fall-back mode the lane commander uses the locally stored pricing information to process transactions. The pricing data may be updated or synchronized when communications connectivity is re-established between the lane commander and the ASP server 105. While operation off-line is not preferred and will not provide access to all point of sale functions available on the ASP server, it will enable subscribers to temporarily process transactions until connectivity with the ASP server is reestablished. During such time, credit card transactions may be completed using a separate mode of communication, such as by dial-up telephone. Sales data (e.g., item data, price data, payment data and the like) are stored in memory of the lane commander until communication with the ASP server is restored. The lane commander can be configured to periodically check for restored communication connectivity with the ASP server. When connectivity is restored, the lane commander can update the stored pricing data and communicate sales data to the ASP server.

Because the lane commander is a thin client and does not consume as much power as a conventional PC, it can be powered on a backup battery for an appreciable period of time.

Sales and transaction data entered into lane commanders using the various input devices are communicated to the ASP server 105 along with the lane commander's unique identification address. The ASP server responds with purchase information (e.g., price, total, financial transaction approval). The ASP server also updates subscribers' databases (e.g., sales and inventory databases). Management information such as purchase orders and received inventory data may also be communicated to the ASP server from either a lane commander or a management computer to update inventory data such as quantities, cost, last purchased dates and prices. The system not only allows for the collection of accurate and detailed information at the time transactions take place, but it may also be used to generate reports to provide valuable insight into day-to-day transactions and assist in the making informed decisions. These functions are typical of conventional point of sale software systems, and the point of sale software hosted on the ASP server is intended to represent a broad category of point of sale software systems, except that the systems are modified to function in an ASP environment for use by multiple subscribers in accordance with the present invention. Of course, the point of sale software system may include fewer, different and/or additional features, elements, and functions, provided it is capable of performing point of sale transaction and management functions in accordance with the present invention.

In a preferred embodiment, the point of sale software hosted on the ASP server for subscribers includes the following features:

International support including operator sensitive and/or customer sensitive languages and multiple currencies, up to four simultaneously, with full audit, conversion and accountability. Further, the system can be configured operate in one language for the customer and simultaneously in a second language for the cashier.

Comprehensive history database that tracks various aspects of a retail business including item movement (hourly, daily, weekly, monthly and perpetual), sales and statistics (store, terminal, department, sub department and more), labor costs, customer purchases, detailed journals, inventory transactions, and may more. Configuration will permit selective retention of histories with no practical limit.

An integrated customer database and targeted marketing system. This connects the identification of customers to transactions and allows configurable changes in transaction flow to be engaged.

A configuration tool which allows control over sensitive and complicated pas transactions such as layaways, special orders, returns, service agreements and much more. Retailers that use this capability do not have to rely on operators or policies to follow procedures that can have a significant impact on costs.

Global promotions and promotion tracking to give unprecedented choices to retailers to engage complex sales promotion and marketing strategies. The system includes optimization so that competing promotions can be resolved to find the best deal to the consumer.

Graphical merchandising features that make use of the graphical displays to interact with customers on a display visible to customers. This is not just a simple presentation of images; it is a complete system that tracks where, and when and how long images are to be displayed, within transactions and as an idle time display. Graphics can also be tied to events within transactions as well.

Built-in operator product recognition training. This is a CBT (computer-based training) component that is specifically targeted toward training operators to recognize items from images and memorize high-speed codes for them. This training feature can be forced into the operator login process, and test results are cataloged and stored for management review. This is a major payback in the grocery industry for recognizing fresh produce brought to the checkout.

Paperless Office. This feature automates daily backroom functions and replaces forms and reports with built-in applications for all types of backroom transactions such as vendor payouts, settlements, accounting adjustments, and many more. Significant labor savings can result from this feature as well as the reduction in paperwork accumulation, accuracy and storage.

Real-time reporting. The system fully updates all aspects of the database as transactions occur making it possible to query and obtain all types of data right up to the second. With the integrated host system, corporate and store management can have detailed and timely reporting on demand.

Other features are:
Media exchange (i.e., Check Cashing)
Discounts by line, transactions and sub-department
Suspend and recall transactions
Item Price checking
Order review and scrolling receipt display
Item lookup search by product name
Age verification (alcohol and tobacco)
Coupon scanning and verifications
Automatic end of day
Pop-up help menus
Cashier monitoring
Coupon summary on receipt
End of order receipt printing
Password protections
Customized receipt messages
Grouping of like items on the receipt
PLU speed keys
Bad Check file

ACR5000™ by ACR Systems, Inc. is an exemplary point of sale software system that is configurable for operation in an ASP mode in accordance with the subject invention. Various features may be offered to subscribers as options.

Advantageously, the ASP model provides a vehicle for combining purchasing power for the overall benefit of each individual subscriber. Demand can be aggregated across multiple subscribers. The aggregated demand may help the subscribers meet minimum volumes required by certain manufacturers and/or qualify for volume discounts. Subscribers may purchase goods and services at substantially reduced prices that result from higher purchasing volumes.

Concomitantly, the ASP model facilitates identifying goods and services required by subscribers. Such information can be determined from transaction data and the nature of the subscribers' businesses. Nearby delivery points can also be readily identified to lower shipping costs.

Typically, there are certain products and services that most, if not all, subscribers will require, irrespective of their type of business. Such services may (for example) include office supplies, telecommunications, payroll processing, computers, software, credit and debit card processing. An exemplary implementation of the invention aggregates subscriber demand to secure volume discounts from vendors for the benefit of the aggregated subscribers. Discounts will be negotiated with third party vendors based on the number of subscribers. Thus, the present invention advantageously provides a means for aggregating demand and strengthening bargaining power for the benefit of subscribers.

Additionally, the ASP server 105 may identify products sold by many subscribers from point of sale transaction data and/or inventory databases according to various rules. In addition, data such as the quantities sold by subscribers, dates of purchase and sale by subscribers, and the locations of subscribers who sell such products, can also be determined by the ASP server. This information is used to aggregate subscriber demand for purposes of securing volume discounts from vendors for the benefit of the aggregated subscribers. The system may determine the products in greatest demand by subscribers, products for which it is estimated that at least a determined volume discount and/or total savings would be available based on aggregated demand, and products in greatest demand in defined geographical areas (i.e., collectively “target products”). Advantageously, these identification and aggregation steps enable the system to recognize new demands (e.g., for new products) that offer new volume discount opportunities. As subscribers cease to demand an obsolete product, the system can omit the product from the aggregated demand.

Once target products and services are identified, negotiations for volume discounts can commence with manufacturers, suppliers and providers. Volume discount opportunities can be communicated to subscribers, such as via the ASP server.

In addition to identifying volume discount opportunities, the system can improve logistical efficiency. It can readily identify subscribers having nearby delivery points (e.g., by zip code). This can facilitate delivery and reduce shipping costs. For example, a truckload of products may be delivered to several subscribers located within the same or adjacent towns.

The ASP server and lane commanders may also be configured to enable subscribers to access and use a wide array of software applications and services. By way of example, the ASP server may host financial management software (e.g., QuickBooks® by Intuit®), customer relationship management software, and any other applications and utilities that may be configured to run in the networked environment. Subscribers may access and use the software through lane commanders. Advantageously, this provides subscribers convenient access to installed, ready-to-use, up-to-date software without the expense of acquisition and the hassle of installation and updating.

An important advantage of the invention is the integration of payment processing with lower transaction fees. Credit card transaction fees become part of the system transaction fee. Anticipated volume discounts result in rates competitive with major retailers. The broadband connection and ASP server also allow faster authorization and processing of credit card transactions.

While the invention has been described in terms of various embodiments and implementations, those skilled in the art will recognize that the invention can be practiced with modification within the spirit and scope of the appended claims.

1. An application service provider point of sale system comprising an ASP server having point of sale software, at least one lane commander for a subscriber, communications connectivity between said at least one lane commander and said server.

2. The system of claim 1, wherein the ASP server further includes demand aggregation software and is configured to determine aggregated demand of products or services by subscribers.

3. The system of claim 1, wherein the lane commander includes memorized pricing data for offline transaction processing.

4. The system of claim 1, wherein the lane commander is adapted to function without an operating system software application.

5. The system of claim 1, wherein the lane commander is adapted to function in fall back mode upon loss of communication with the ASP server.

6. The system of claim 1, wherein the lane commander is adapted to function in fall back mode upon loss of communication with the ASP server.

7. An application service provider point of sale system comprising an ASP server having point of sale software, at least one lane commander for a subscriber, communications connectivity between said at least one lane commander and said server, said ASP server further including demand aggregation software and is configured to determine aggregated demand of products or services by subscribers, and said lane commander including memory adapted for storing pricing data for offline transaction processing.

8. The system of claim 7, wherein the lane commander is adapted to function without an operating system software application.

9. The system of claim 8, wherein the lane commander is adapted to function in fall back mode upon loss of communication with the ASP server.

10. The system of claim 9, wherein the lane commander is adapted to function in fall back mode upon loss of communication with the ASP server.

11. An application service provider point of sale business method comprising steps of:
providing an ASP server having point of sale software for access and use by a plurality of subscribers,
establishing an account for each of said plurality subscribers on said ASP server for the point of sale software,
providing at least one lane commander for each of said plurality of subscribers to access the ASP server,
charging said plurality of subscribers fees based on point of sale transactions processed using the ASP server having point of sale software.

12. An application service provider point of sale business method according to claim 11, wherein said business method further includes a step of securing discounts for third party products or services purchased by said plurality of subscribers.

13. An application service provider point of sale business method according to claim 12, further comprising steps of:
communicating point of sale transaction requests from a remote lane commander to the ASP server,
processing said point of sale transaction request to produce transaction output using the ASP server, and
transmitting said transaction output from the ASP server to said lane commander.
